(19) United States
(12) Patent Application Publication
(10) Pub. No.: US 2010/0011401 A1
(43) Pub. Date: Jan. 14, 2010

(54) METHOD, SYSTEM AND APPARATUS FOR APPLYING TERMINAL CAPABILITY INFORMATION IN IPTV SERVICE

(75) Inventors: Zhaojun Peng, Shenzhen (CN); Feng Wang, Shenzhen (CN); Jun Yan, Shenzhen (CN)

Correspondence Address: Huawei Technologies Co., Ltd.;c/o Darby & Darby P.C., P.O. Box 770, Church Street Station, New York, NY, 10008-0770, US

(73) Assignee: HUAWEI TECHNOLOGIES CO., LTD., Shenzhen (CN)

(21) Appl. No.: 12/564,191

(22) Filed: Sep. 22, 2009

Related U.S. Application Data
(63) Continuation of application No. PCT/CN2008/070764, filed on Apr. 22, 2008.

(30) Foreign Application Priority Data
Apr. 30, 2007 (CN) 200710101585.6

(51) Int. Cl. H04N 7/173

(52) U.S. Cl. 725/116

(57) ABSTRACT

A system, an apparatus and a method for applying terminal capability information in an IPTV service are provided. The system includes a user equipment (UE), a Core IP multimedia subsystem (Core IMS), a device profile function (DPF) and an application server, wherein, the UE is configured to transmit the terminal capability information and receive the IPTV service; the Core IMS is configured to forward the terminal capability information received from the user equipment to the DPF; the DPF is configured to transmit the terminal capability information to the application server; and the application server is configured to provide the IPTV service for the UE according to the terminal capability information. The method comprises: receiving terminal capability information transmitted by a UE via a Core IMS; providing the IPTV service for the UE according to the acquired terminal capability information.

### CROSS-REFERENCE TO RELATED APPLICATIONS

This application is a continuation of International Patent Application No. PCT/CN2008/070764, filed on Apr. 22, 2008, which claims priority to Chinese Patent application No. 200710101585.6, filed on Apr. 30, 2007, both of which are incorporated by reference herein in their entireties.

### FIELD OF THE INVENTION

The present disclosure relates to a technology for implementing Internet Protocol Television (IPTV) in a network, and in particular, to a method, a system and an apparatus for applying terminal capability information in an IPTV service.

### BACKGROUND

At present, with rapid development of communication networks, as Internet Protocol (IP) technology for the cross-link layer transmission medium emerges and the application of Internet is popularized, a single speech communication mode is no longer sufficient, and brand-new multimedia communication mode is desired. Therefore, the IP-based mobile communication network and fixed communication network as well as integration of Internet and telecommunication network have become an acknowledged development direction without controversy in this field. In order to meet more and more outstanding general requirements for IP multimedia applications, the Next Generation Network (NGN) has been proposed. For example, an IP multimedia subsystem (IMS) based upon a complete IP service network architecture is introduced on the basis of packet bearing network with the purpose of shielding subscriber access modes, controlling an open degree of service capability and providing multimedia communication experience according to individualized subscriber data.

The IMS is superposed on a packet domain network and consists of a call session control function entity (CSCF), a media gateway control function entity (MGCF), a media resource function entity (MRF) and a home subscriber server (HSS) and so on. The CSCF may further be divided into three logic entities, i.e. a service CSCF (S-CSCF), a proxy CSCF (P-CSCF) and an inquiry CSCF (I-CSCF). The S-CSCF is a service switching center of the IMS, and the S-CSCF is configured to perform session control, maintain session status, manage terminal information and generate billing information. The P-CSCF is an access point for a terminal to access the IMS, and the P-CSCF is configured to implement terminal registration, control quality of service (QoS) and perform security management. The I-CSCF is configured to be responsible for intercommunication among IMS domains, manage assignment and selection of the S-CSCF, conceal topology and configuration of a network from outside and generate billing data. The MGCF is configured to control gateway and implement intercommunication between the IMS and other networks. The MRF is configured to provide media resources. The HSS is configured to store subscription data and configuration information of a terminal.

In an IMS network, a Session Initiation Protocol (SIP) is used as the signaling control protocol for an IP multimedia session. The SIP is an IP phone signaling protocol proposed by the Internet Engineering Task Force. The SIP is configured to initiate a session, control establishment and termination of a multimedia session in which a plurality of participants take part, and can dynamically adjust and modify session attributes such as a session bandwidth requirement, a type of transmitted media (voice, video and text), coding and decoding formats for media and support for multicast and unicast and so on.

An IPTV service is a service that has developed rapidly in the last few years. The IPTV service transmits multimedia files including video and audio file contents over packet switching networks by means of a stream transmission technology. When accessing these contents, a terminal can play back these contents immediately without having to download them completely. The IPTV service mainly provides a live television (LTV) service and a video on demand (VOD) service and so on.

Presently, the IPTV service may be carried in an NGN, such as an IMS for implementation. FIG. 1 is an architecture diagram of an IMS network carrying the IPTV service, which includes a user equipment (UE), an application server (AS), a user profile server function (UPSF), an IMS core network (IMS Core, also known as Core IMS), a media function (MF) and a transport layer.

The UE is configured to transmit an IPTV service request to the AS via the IMS Core.

The AS is configured to receive information related to UE management and configuration service, receive the IPTV service request, acquire user profile information from the UPSF, implement IPTV service logic and control provision of the IPTV service via the IMS Core.

The UPSF is configured to store user profile information.

The IMS Core is configured to perform session control for the IPTV service request transmitted by the UE according to the user profile information obtained from the UPSF and to exchange information with the MF.

The MF is configured to provide IPTV service content transmission for the UE via the Transport Layer.

In the network as shown in FIG. 1, the IPTV service may be provided for the UE via the IMS. However, the UPSF in the IMS only stores user profile information and does not store terminal capability information. Further, a Ut interface between the AS and the UE is only adapted to perform security management of the UE and configure information on UE′ network service on the AS. Therefore, the network shown in FIG. 1 can not collect and apply the terminal capability information in real time.

For the network side for providing the IPTV service, a control policy may be determined according to the terminal capability information, and the IPTV service is provided in a manner suitable for the UE to receive the IPTV service. It is also required to adjust a mode for providing the IPTV service according to variation of terminal capability information. However, if the architecture shown in FIG. 1 is used, the terminal capability information can not be acquired, which will have a strong impact on user experience on IPTV service and result in a huge obstacle to large-scale commercial deployment of the IPTV service.

### SUMMARY

An embodiment of the present disclosure provides a method for applying terminal capability information in an Internet Protocol Television (IPTV) service. The method is capable of applying the terminal capability information while providing the IPTV service for a UE.

An embodiment of the present disclosure further provides a system for applying terminal capability information in an Internet Protocol Television (IPTV) service. The system is capable of applying the terminal capability information while providing the IPTV service for a UE.

An embodiment of the present disclosure further provides an apparatus for applying terminal capability information in an Internet Protocol Television (IPTV) service. The apparatus is capable of applying the terminal capability information while providing the IPTV service for a UE.

According to the above-mentioned objects, the technical solutions of embodiments of the present disclosure are implemented as follows.

A system for applying terminal capability information in an Internet Protocol Television (IPTV) service is provided which includes a UE, a Core IP multimedia subsystem (Core IMS), a device profile function (DPF) and an application server.

The UE is configured to transmit the terminal capability information and receive the IPTV service.

The Core IMS is configured to forward the terminal capability information received from the UE to the DPF.

The DPF is configured to transmit the terminal capability information to the application server.

The application server is configured to provide the IPTV service for the UE according to the terminal capability information.

An apparatus for applying terminal capability information in an Internet Protocol Television (IPTV) service is provided which includes a receiving module and a transmitting module.

The receiving module is configured to receive the terminal capability information and transmit the terminal capability information to the transmitting module.

The transmitting module is configured to transmit the terminal capability information received from the receiving module.

An apparatus for applying terminal capability information in an Internet Protocol TV service is provided which includes a receiving module, a transmitting module and an applying module.

The receiving module is configured to receive the terminal capability information and transmit the terminal capability information to the transmitting module.

The transmitting module is configured to receive the terminal capability information from the receiving module and transmit the terminal capability information to the applying module.

The applying module is configured to provide the IPTV service for the UE according to the terminal capability information received from the transmitting module.

A method for applying terminal capability information in an Internet Protocol Television (IPTV) service is provided. The method includes: receiving the terminal capability information transmitted by a UE via a Core IMS; and providing the IPTV service for the UE according to the acquired terminal capability information.

As can be seen from the above-mentioned aspects, in embodiments of the present disclosure, UE's terminal capability information is acquired and an IPTV service is provided in a manner that is suitable for a UE to receive the IPTV service according to the acquired terminal capability information. Therefore, the method, system and apparatus provided in embodiments of the present disclosure may apply the terminal capability information while providing the IPTV service for a UE.

### BRIEF DESCRIPTION OF THE DRAWING(S)

FIG. 1 is an architecture diagram of an IMS network for providing an IPTV service according to the prior art;

FIG. 2 is a schematic architecture diagram of the first system for applying terminal capability information in an IMS-based IPTV service according to an embodiment of the present disclosure;

FIG. 3 is a schematic architecture diagram of the first apparatus for applying terminal capability information in an IMS-based IPTV service according to an embodiment of the present disclosure;

FIG. 4 is a flow chart of the method for a UE to actively report terminal capability information according to an embodiment of the present disclosure;

FIG. 5 is a flow chart of the method for a DPF to actively inquire of a UE about terminal capability information according to an embodiment of the present disclosure;

FIG. 6 is a flow chart of the method for providing terminal capability information according to an embodiment of the present disclosure;

FIG. 7 is a flow chart of the method for acquiring terminal capability information in proxy mode according to an embodiment of the present disclosure;

FIG. 8 is a flow chart of the first method for applying terminal capability information in an IMS-based IPTV service according to an exemplary embodiment of the present disclosure;

FIG. 9 is a flow chart of the second method for applying terminal capability information in an IMS-based IPTV service according to an exemplary embodiment of the present disclosure;

FIG. 10 is a flow chart of the third method for applying terminal capability information in an IMS-based IPTV service according to an exemplary embodiment of the present disclosure;

FIG. 11 is a flow chart of the fourth method for applying terminal capability information in an IMS-based IPTV service according to an exemplary embodiment of the present disclosure;

FIG. 12 is a flow chart of the fifth method for applying terminal capability information in an IMS-based IPTV service according to an exemplary embodiment of the present disclosure;

FIG. 13 is a flow chart of the sixth method for applying terminal capability information in an IMS-based IPTV service according to an exemplary embodiment of the present disclosure;

FIG. 14 is a flow chart of the seventh method for applying terminal capability information in an IMS-based IPTV service according to an exemplary embodiment of the present disclosure;

FIG. 15 is a flow chart of the eighth method for applying terminal capability information in an IMS-based IPTV service according to an exemplary embodiment of the present disclosure;

FIG. 16 is a flow chart of the ninth method for applying terminal capability information in an IMS-based IPTV service according to an exemplary embodiment of the present disclosure;

FIG. 17 is a schematic architecture diagram of the third system for applying terminal capability information in an IMS-based IPTV service according to an embodiment of the present disclosure;

FIG. 18 is a schematic architecture diagram of the second system for applying terminal capability information in an IMS-based IPTV service according to an embodiment of the present disclosure;

FIG. 19 is a schematic architecture diagram of the second apparatus for applying terminal capability information in an IMS-based IPTV service according to an embodiment of the present disclosure; and

FIG. 20 is a flow chart of the sixth method for applying terminal capability information in an IPTV service according to the second solution of an exemplary embodiment of the present disclosure.

### DETAILED DESCRIPTION

To make the objects, technical aspects and advantages of the present disclosure clearer, further detailed description is given for embodiments of the present disclosure with reference to the drawings.

According to an embodiment of the present disclosure, before or during providing an IPTV service for a UE, the terminal capability information of the UE is acquired and the IPTV service is provided in a manner suitable for the UE to receive the IPTV service according to the acquired terminal capability information.

According to an embodiment of the present disclosure, there are three aspects for acquiring the terminal capability information of a UE. In the first aspect, a device profile function (DPF) is arranged in a network carrying an IPTV service and an AS acquires the terminal capability information of the UE via the DPF. In another aspect, the AS acquires the terminal capability information from the UE. In yet another aspect, the DPF is integrated in the AS and there is an internal interface between the DPF and the AS through which the AS acquires the terminal capability information from the DPF. As an example, it is assumed that the network carrying IPTV service is an IMS, and these three aspects will be described in detail.

The first aspect and the third aspect

In order to be capable of applying the terminal capability information of the UE while providing the IPTV service for the UE, a DPF is provided in a network carrying the IPTV service, and the DPF is configured to interact with the UE to enable the AS to acquire the terminal capability information in different manners.

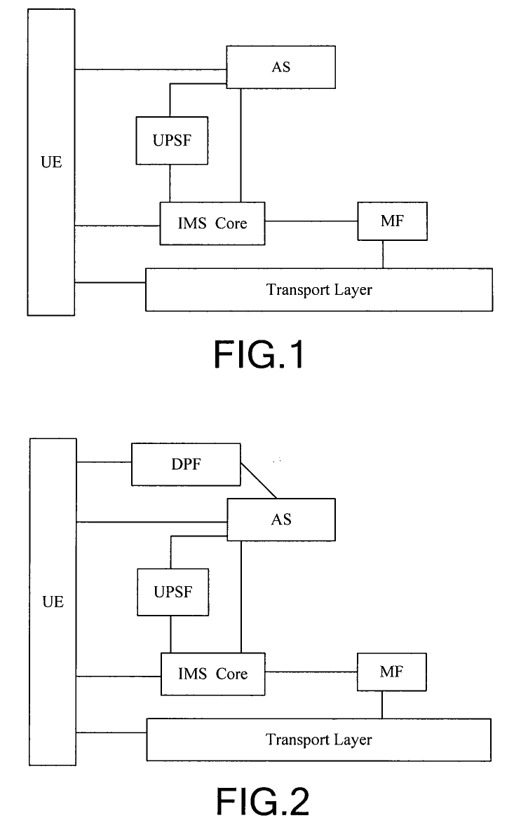

FIG. 2 is a schematic architecture diagram of the first system for applying terminal capability information in an IMS-based IPTV service according to an embodiment of the present disclosure. As shown, in the embodiment of the present disclosure, a DPF is added for interacting with the UE and AS respectively on the basis of FIG. 1.

The UE is configured to transmit the terminal capability information.

The DPF is configured to transmit the received terminal capability information to the AS or transmit the received terminal capability information inquiry request to the UE.

The AS is configured to transmit the terminal capability information inquiry request or provide the IMS-based IPTV service for the UE according to the received terminal capability information.

In this embodiment, the UE may actively transmit the terminal capability information to the DPF; or may transmit the terminal capability information to the DPF after receiving the terminal capability information inquiry request transmitted by the DPF.

In this embodiment, the DPF may store the terminal capability information transmitted by the UE and transmit the stored terminal capability information to the AS after the AS transmits the terminal capability information inquiry request to the DPF.

In this embodiment, the AS may transmit the terminal capability information inquiry request to the DPF. The DPF may operate in the following three ways when determining that it is necessary to request the UE for the terminal capability information:

One way is a proxy mode in which the AS transmits the terminal capability information inquiry request to the DPF, the DPF transmits the terminal capability information inquiry request to the UE according to this request and the UE transmits its terminal capability information to the AS via the DPF. Another way is a routing mode in which the AS transmits the terminal capability information inquiry request to the DPF, the DPF routes the inquiry request to the UE and the UE transmits its terminal capability information to the AS. Yet another way is a redirecting mode in which the DPF transmits UE identification to the AS, the AS transmits the terminal capability information inquiry request to the UE directly and the UE transmits its terminal capability information to the AS.

For carrying out interaction between the DPF and the UE and interaction between the DPF and the AS, an I1 interface between the DPF and the UE is provided for transmitting the terminal capability information and the terminal capability information inquiry request. An I2 interface between the DPF and the AS is also provided for transmitting the terminal capability information and the terminal capability information inquiry request.

In an embodiment of the present disclosure, the terminal capability information inquiry request includes inquiry content having terminal capability attribute inquiry information or terminal capability attribute inquiry information containing reporting conditions. The reporting condition is immediate reporting, timed reporting or conditional reporting. The terminal capability attribute inquiry information is one of attribute inquiry information for at least one terminal capability and attribute inquiry information for a combination of a plurality of capability attributes.

The terminal capability information inquiry request may be an inquiry request for at least one piece of terminal capability information.

When the third aspect is used for implementing an embodiment of the present disclosure, since a DPF is integrated in an AS, an interface between the AS and the DPF is an internal interface.

In an embodiment of the present disclosure, the terminal capability information and/or the terminal capability information inquiry request may be transmitted between a UE and a DPF via other network elements in the network. For example, the UE transmits the terminal capability information and/or the terminal capability information inquiry request to the DPF via a P/I/S-CSCF, UPSF and/or a general user profile entity (GUP) in an IMS Core. The terminal capability information and/or the terminal capability information inquiry request may also be transmitted between a UE and an AS via other network elements in the network. For example, the UE transmits the terminal capability information and/or the terminal capability information inquiry request to the AS via a P/I/S-CSCF, a UPSF and/or a GUP in an IMS Core. The terminal capability information and/or the terminal capability information inquiry request may also be transmitted between a DPF and an AS via other network elements in the network. For example, the UE transmits the terminal capability information and/or the terminal capability information inquiry request to the DPF via a P/I/S-CSCF, a UPSF and/or a GUP in IMS Core.

Alternatively, the terminal capability information and/or the terminal capability information inquiry request may also be transmitted directly between a UE and a DPF, between a UE and an AS and between a DPF and an AS.

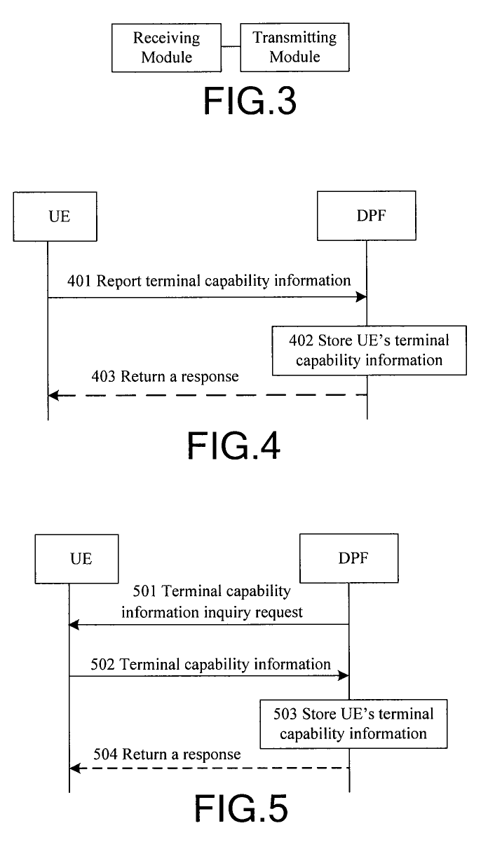

FIG. 3 is a schematic architecture diagram of the first apparatus for applying terminal capability information in an IPTV service according to an embodiment of the present disclosure. As shown, the apparatus includes a receiving module and a transmitting module.

The receiving module is configured to receive the terminal capability information and transmit the terminal capability information to the transmitting module.

The transmitting module is configured to transmit the terminal capability information received from the receiving module.

The receiving module is also configured to receive a terminal capability information inquiry request and transmit the terminal capability information inquiry request to the transmitting module.

The transmitting module is also configured to transmit the terminal capability information inquiry request received from the receiving module.

Specifically, the receiving module is configured to receive the terminal capability information from the UE and the transmitting module is configured to transmit the terminal capability information to an application server.

Specifically, the receiving module is configured to receive the terminal capability information inquiry request from the application server and the transmitting module is configured to transmit the terminal capability information inquiry request to the terminal equipment.

The DPF may acquire the terminal capability information in two modes as shown in FIG. 4 and FIG. 5 respectively. FIG. 4 is a flow chart of the method for a UE to actively report the terminal capability information. Specific steps are as follows.

In step 401, the UE reports the terminal capability information to the DPF.

In step 402, after receiving the terminal capability information, the DPF stores the received terminal capability information.

In step 403, the DPF returns a response to the UE. This step is optional.

FIG. 5 is a process for a DPF to actively inquire of a UE about terminal capability information. Specific steps are as follows.

In step 501, the DPF transmits the terminal capability information inquiry request to the UE.

In step 502, the terminal capability information is returned to the UE after the UE receives the request.

In step 503, after receiving the terminal capability information, the DPF stores the received terminal capability information.

In step 504, the DPF returns a response to the UE. This step is optional.

In FIG. 4 or FIG. 5, the UE may report the terminal capability information to the DPF by means of an I1 interface directly, and may also report the terminal capability information to the DPF by interacting with the DPF via other network elements. For example, the UE may report the terminal capability information by interacting with the DPF via an I/P/S-CSCF, a UPSF and/or a GUP in an IMS Core.

The provision of terminal capability information will be described in detail hereinafter.

In this embodiment, before the establishment of an IPTV service, the AS selects the most suitable IPTV service contents for the UE and provides suitable transmittal mode for providing the IPTV service contents for the UE by acquiring the UE's terminal capability information such as resolution, decoding capability, screen size and remaining memory size of the UE.

During the provision of the IPTV service, the UE's terminal capability information, such as occupation ratio of the UE's CPU, residual capacity of a battery and an uplink connection bandwidth will vary with time. The AS is required to provide the most suitable IPTV traffic flow for the UE by acquiring the UE's terminal capability information that may influence currently provided IPTV service in real time.

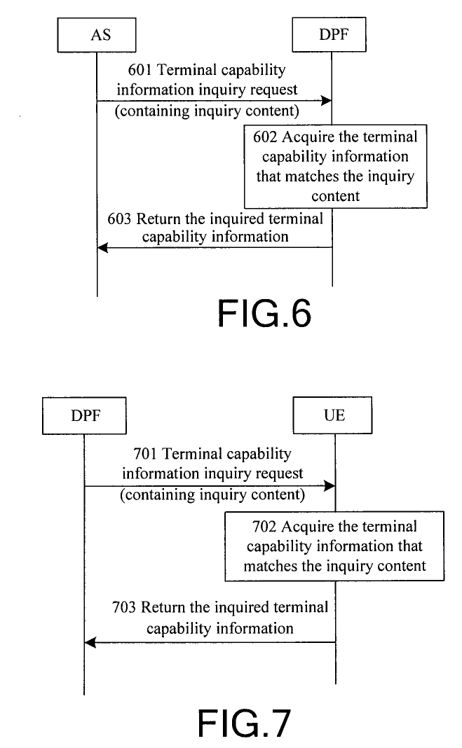

FIG. 6 is a flow chart of the method for providing terminal capability information according to an embodiment of the present disclosure. Specific steps are as follows.

In step 601, an AS transmits a terminal capability information inquiry request to a DPF which carries inquiry content.

The inquiry content carried in the terminal capability information inquiry request includes terminal capability attribute inquiry information or terminal capability attribute inquiry information containing reporting condition. The reporting condition is immediate reporting, timed reporting or conditional reporting. The terminal capability attribute inquiry information is attribute inquiry information for at least one terminal capability.

In an embodiment of the present disclosure, the terminal capability information inquiry request is an inquiry request for at least one piece of terminal capability information.

In step 602, the DPF receives the request and acquires the terminal capability information that matches the inquiry content.

In step 603, the DPF transmits the terminal capability information to the AS.

The DPF may acquire the terminal capability information that matches the inquiry content carried in the request in two ways. As the first way, the DPF itself stores the terminal capability information corresponding to the inquiry content, and then the DPF returns the terminal capability information to the AS. As the second way, if the DPF determines that the DPF itself has not stored the terminal capability information corresponding to the inquiry content, then DPF may further acquire the terminal capability information in proxy mode, as shown in FIG. 7.

FIG. 7 is a flow chart of the method for acquiring terminal capability information in proxy mode according to an embodiment of the present disclosure. Specific steps are as follows.

In step 701, a DPF transmits a terminal capability information inquiry request to a UE which carries inquiry content according to the terminal capability information inquiry request transmitted by an AS.

The terminal capability information inquiry request transmitted to the UE may be the same as the inquiry request transmitted by the AS to the DPF or may be an updated terminal capability information inquiry request. For example, the reporting condition information carried in the inquiry content may be updated reporting condition information.

In this step, there may be one or more UEs. The DPF transmits terminal capability information inquiry requests respectively. The inquiry content may also be single or a plurality of capability attributes, or may also be combination of a plurality of capability attributes. The reporting condition in the inquiry content may be timed reporting and conditional reporting.

In step 702, the UE acquires the terminal capability information that matches the inquiry content.

In step 703, the UE returns the terminal capability information to the DPF.

Besides the proxy mode in which the DPF provides the terminal capability information to the AS, routing or redirecting mode may also be used. In the routing mode, the DPF forwards the terminal capability information inquiry request transmitted by the AS to the UE, and the UE returns the terminal capability information that matches the inquiry content carried in the request to the AS. In the redirecting mode, the DPF returns UE identification to the AS, the AS transmits the terminal capability information inquiry request to the UE and the UE returns the terminal capability information that matches the inquiry content carried in the inquiry to the AS.

Several specific embodiments will be explained below to illustrate the first aspect. The first aspect is an aspect in which a DPF is provided in the network carrying an IPTV service and an AS acquires a UE's terminal capability information via the DPF.

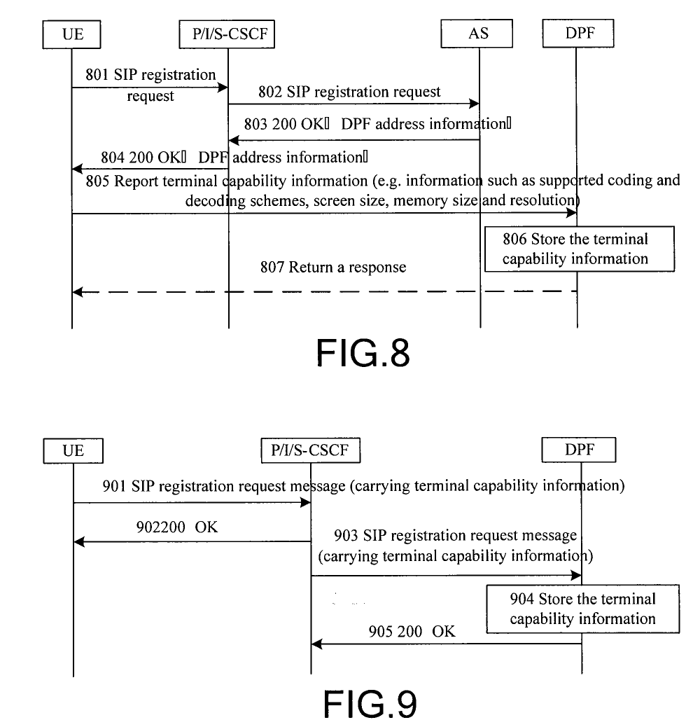

FIG. 8 is a flow chart of the first method for applying terminal capability information in an IMS-based IPTV service according to an exemplary embodiment of the present disclosure. A description will be given with the following case as an example, in which case a UE acquires DPF address information in advance in a third party registration mode and reports the terminal capability information to a DPF directly via an I1 interface. Specific steps are as follows.

In step 801, a user logs on via a UE and transmits a SIP registration request to an IMS Core.

In step 802, an S-CSCF in the IMS Core which is used as a proxy of the UE transmits a third party registration to an AS.

In step 803, the AS completes the UE's third party registration and returns a third party registration success response to the S-CSCF which carries DPF address information.

In this step, the DPF address information is preset by the AS or acquired from a network element having the DPF address information.

In step 804, the IMS Core returns the registration success response carrying the DPF address information to the UE.

In step 805, the UE reports the terminal capability information to the DPF according to the acquired DPF address information, such as supported coding/decoding schemes, size of terminal screen, memory size and resolution and so on.

In step 806, the DPF stores the received terminal capability information.

In step 807, the DPF returns a response to the UE. This step is optional.

FIG. 9 is a flow chart of the second method for applying terminal capability information in an IMS-based IPTV service according to an exemplary embodiment of the present disclosure. A description will be given with the following case as an example, in which case a UE performs a third party registration with a DPF and reports the terminal capability information to the DPF via an S-CSCF. Specific steps are as follows.

In step 901, a user logs on via a UE and transmits a SIP registration request which carries the terminal capability information to an IMS Core.

In step 902, the IMS Core returns an IMS Core registration success response to the UE (200 OK).

In step 903, an S-CSCF in the IMS Core which is used as a proxy of the UE transmits a third party registration carrying the terminal capability information to a DPF.

In step 904, the DPF stores the terminal capability information.

In step 905, the DPF returns a third party registration success response to the S-CSCF (200 OK).

In this embodiment, steps 901 to 905 are schematic description of IMS registration and third party registration procedures. It's only an embodiment of the IMS registration and third party registration procedures and specific implementations are not limited thereto.

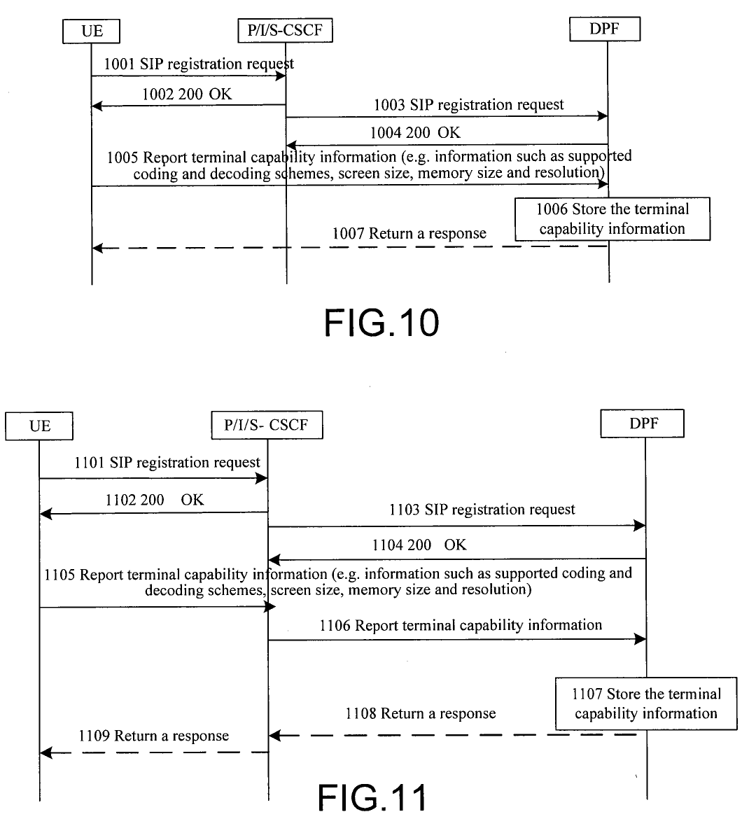

FIG. 10 is a flow chart of the third method for applying terminal capability information in an IMS-based IPTV service according to an exemplary embodiment of the present disclosure. A description will be given with the following case as an example, in which case a UE performs a third party registration with a DPF and reports the terminal capability information to the DPF directly via an I1 interface after a successful registration. Specific steps are as follows.

In step 1001, a user logs on via a UE and transmits a SIP registration request to an IMS Core.

In step 1002, the IMS Core returns an IMS Core registration success response to the UE (200 OK).

In step 1003, an S-CSCF in the IMS Core which is used as a proxy of the UE transmits a third party registration to a DPF.

In step 1004, the DPF returns a third party registration success message to the S-CSCF.

In step 1005, the UE reports the terminal capability information to the DPF, such as supported coding and decoding schemes, terminal screen size, memory size and resolution, and determines whether DPF address information of the DPF may be statically configured on the UE or acquired in other ways.

In step 1006, the DPF stores the received terminal capability information.

In step 1007, the DPF returns a response to the UE. This step is optional.

In the embodiment, steps 1001 to 1004 are schematic description of IMS registration and third party registration procedures and specific implementations are not limited thereto.

FIG. 11 is a flow chart of the fourth method for applying terminal capability information in an IMS-based IPTV service according to an exemplary embodiment of the present disclosure. A description will be given with the following case as an example, in which case a UE performs a third party registration with a DPF and reports the terminal capability information to the DPF directly via an IMS Core after successful registration. Specific steps are as follows.

In step 1101, a user logs on via a UE and transmits a SIP registration request to an IMS Core.

In step 1102, the IMS Core returns an IMS Core registration success response to the UE (200 OK).

In step 1103, an S-CSCF in the IMS Core which is used as a proxy of the UE transmits a third party registration to the DPF.

In step 1104, the DPF returns a third party registration success message to the S-CSCF.

In step 1105, the UE reports the terminal capability information to the IMS Core, such as supported coding and decoding schemes, terminal screen size, memory size and resolution, and determines whether DPF address information of the DPF may be statically configured on the UE or acquired in other ways.

In step 1106, the IMS Core forwards the reported terminal capability information to the DPF.

In step 1107, the DPF stores the terminal capability information.

In step 1108, the DPF returns a response to the IMS Core.

In step 1109, the IMS Core returns a response to the UE.

Steps 1101 to 1104 are schematic description of IMS registration and third party registration procedures and specific implementations are not limited thereto.

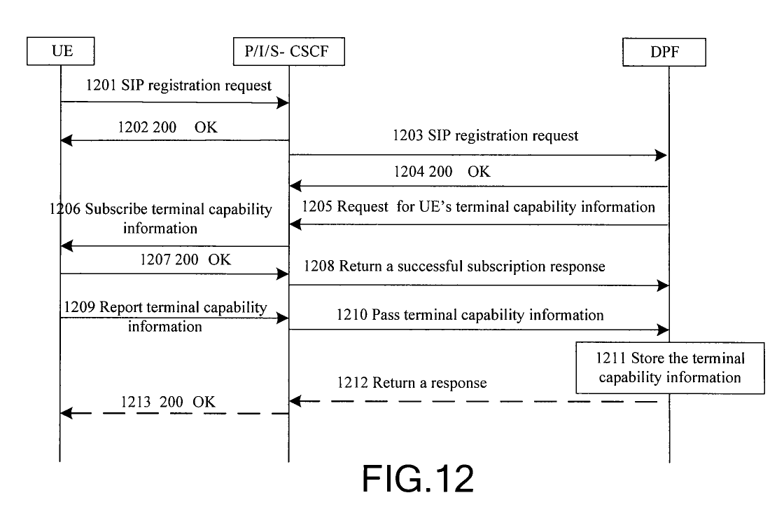

FIG. 12 is a flow chart of the fifth method for applying terminal capability information in an IMS-based IPTV service according to an exemplary embodiment of the present disclosure. A description will be given with the following case as an example, in which case a UE performs a third party registration with a DPF and the DPF subscribes the terminal capability information from the UE via an S-CSCF. Specific steps are as follows.

In step 1201, a user logs on via a UE and transmits a SIP registration request to an IMS Core.

In step 1202, the IMS Core returns an IMS Core registration success response to the UE (200 OK).

In step 1203, an S-CSCF in the IMS Core which is used as a proxy of the UE transmits a third party registration to a DPF.

In step 1204, the DPF returns a third party registration success message to the S-CSCF.

In step 1205, the DPF requests the UE's terminal capability information from the S-CSCF.

In step 1206, the S-CSCF subscribes the terminal capability information from the UE.

In step 1207, the UE returns a subscription success response message to the S-CSCF.

In step 1208, the UE transmits the terminal capability information to the S-CSCF.

In step 1209, the S-CSCF transmits the terminal capability information received from the UE to the DPF.

In step 1210, the DPF stores the received terminal capability information.

In step 1211, the DPF returns a response to the S-CSCF. This step is optional.

In step 1212, the S-CSCF returns a response to the UE. This step is optional.

Steps 1201 to 1204 are schematic description of IMS registration and third party registration procedures and specific implementations are not limited thereto.

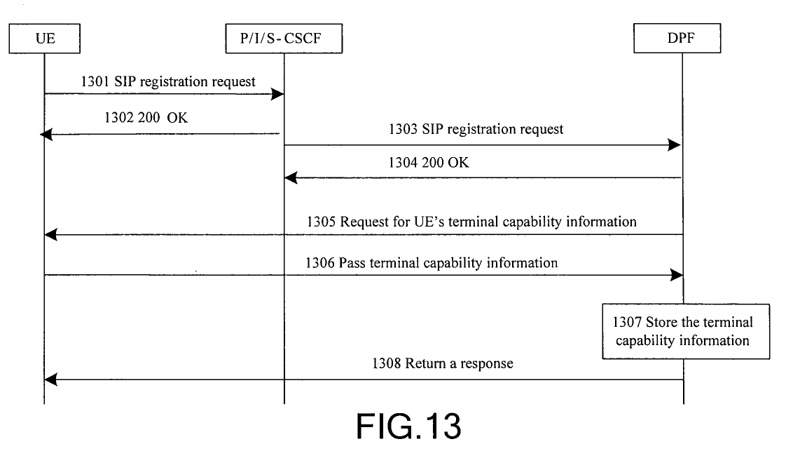

FIG. 13 is a flow chart of the sixth method for applying terminal capability information in an IMS-based IPTV service according to an exemplary embodiment of the present disclosure. A description will be given with the following case as an example, in which case a UE performs third party registration with a DPF and inquires of the UE about the terminal capability information directly via an I1 interface after successful registration. Specific steps are as follows.

In step 1301, a user logs on via a UE and transmits a SIP registration request to an IMS Core.

In step 1302, the IMS Core returns an IMS Core registration success response to the UE (200 OK).

In step 1303, an S-CSCF in the IMS Core which is used as a proxy of the UE transmits a third party registration to a DPF.

In step 1304, the DPF returns a third party registration success message to the S-CSCF.

In step 1305, the DPF transmits a terminal capability information inquiry request to the UE.

In step 1306, the UE returns the terminal capability information to the DPF.

In step 1307, the DPF stores the terminal capability information returned from the UE.

In step 1308, DPF returns a response to the UE. This step is optional.

Steps 1301 to 1304 are schematic description of IMS registration and third party registration procedures and specific implementations are not limited thereto.

For the above six embodiments, the terminal capability information is transmitted during or after the UE performs an IMS registration process. However, specific implementations are not limited thereto. The UE may transmit the terminal capability information at any other time, which doesn't necessarily associate with an IMS registration process.

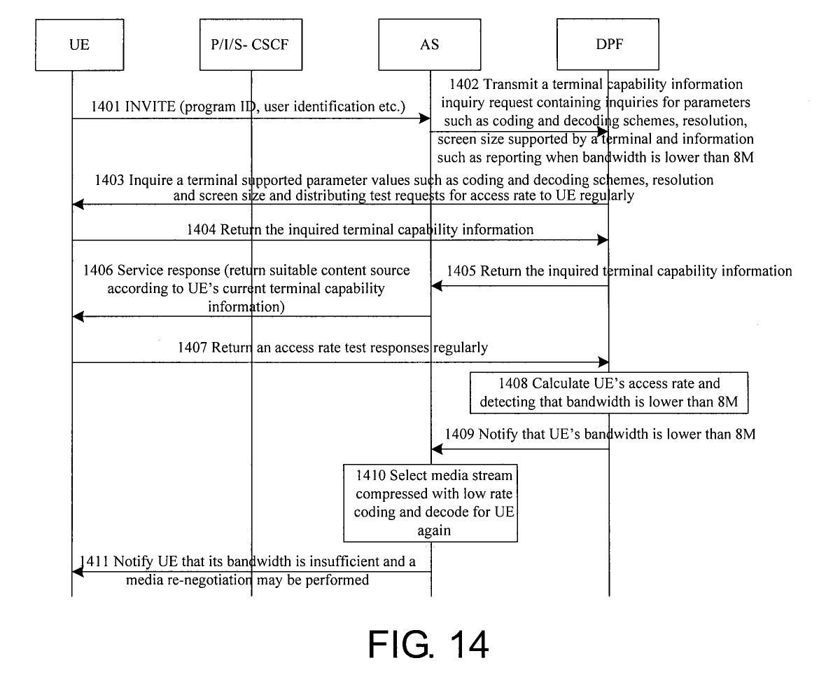

FIG. 14 is a flow chart of the seventh method for applying terminal capability information in an IMS-based IPTV service according to an exemplary embodiment of the present disclosure. A description will be given with the following case as an example, in which case a user watches VOD service via a UE, a DPF acquires the UE's terminal capability information in proxy mode and reports the terminal capability information to an AS when the UE's access rate is lower than 8M, and the AS selects an IPTV Content with new codec which has lower rate for the UE again. Specific steps are as follows.

In step 1401, a UE transmits an IP visiting (INVITE) request carrying information such as channel ID and UE identification to an AS via a P/I/S-CSCF.

In step 1402, the AS transmits a terminal capability information inquiry request to a DPF, which contains inquiries for parameters such as coding and decoding schemes, resolution, screen size supported by a terminal and information such as reporting when a bandwidth is lower than 8M.

In step 1403, the DPF, as a proxy of the AS, transmits a terminal capability information inquiry request to the UE, which contains inquiries for parameters such as coding and decoding schemes, resolution and screen size supported by a terminal, and distributes test requests for access rate to the UE regularly.

In step 1404, the UE returns the inquired terminal capability values such as support for H.264 and MPEG4 in terms of coding and decoding schemes, support for HDTV, support for 1080p in terms of screen, and bandwidth of 9M, to the DPF after receiving the request.

In step 1405, the DPF returns the inquired terminal capability values to the AS.

In step 1406, the AS returns a service response to the UE and selects suitable IPTV service content source for the UE according to information carried in the IP INVITE request and the returned terminal capability information.

For example, if it is considered comprehensively that the UE supports high definition and bandwidth is sufficient, then high definition media stream is selected to distribute for the UE.

In step 1407, the UE returns an access rate test response to the DPF regularly.

In step 1408, the DPF calculates the access rate according to the response and monitors that the UE's access bandwidth is lower than 8M.

In step 1409, the DPF notifies the AS that the UE's access bandwidth is lower than 8M.

In step 1410, the AS selects media stream compressed with low rate coding and decoding schemes for UE again and can only select IPTV service contents with standard definition for distribution again in consideration of insufficient bandwidth.

In step 1411, the AS notifies the UE that the bandwidth is insufficient and a media re-negotiation may be performed.

This embodiment is explained only with the case as an example in which case the UE transmits the terminal capability information or response to the DPF directly. For specific implementation, the terminal capability information or response may also be transmitted via other network elements such as an IMS Core.

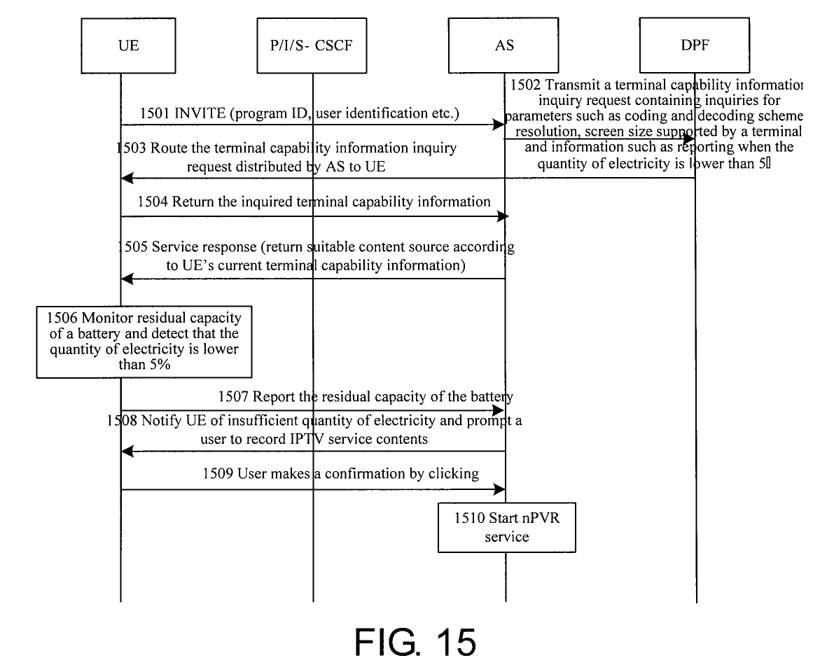

FIG. 15 is a flow chart of the eighth method for applying terminal capability information in an IMS-based IPTV service according to an exemplary embodiment of the present disclosure. A description is given with the following case as an example, in which case a user watches an LTV service via a UE, a DPF transmits the UE's terminal capability information inquired by an AS in routing mode, and the UE is required to report a case in which the battery capacity is lower than 5% to the AS, the AS alerts the user that the quantity of electricity is insufficient and prompts the user if recording is needed, and the AS performs nPVR service control after the user makes a confirmation via the UE. Specific steps are as follows.

In step 1501, a UE transmits an IP INVITE request carrying information such as channel ID and UE identification to an AS via a P/I/S-CSCF.

In step 1502, the AS transmits a terminal capability information inquiry request to a DPF, which contains inquiries for parameters such as coding and decoding schemes, resolution, screen size supported by a terminal and information such as reporting when quantity of electricity is lower than 5%.

In step 1503, the DPF routes the terminal capability information inquiry request transmitted by the AS to the UE.

In step 1504, the UE returns the inquired terminal capability values such as support for H.264 and MPEG4 in terms of coding and decoding schemes, support for HDTV, support for 1080p in terms of screen and bandwidth of 5M, to the AS after receiving the request.

In step 1505, the AS returns a service response to the UE and selects suitable IPTV service content source for the UE according to information carried in the IP INVITE request and the returned terminal capability information. For example, if it is considered comprehensively that the UE supports high definition but the bandwidth is insufficient, then IPTV service contents with standard definition can only be selected to distribute for the UE.

In step 1506, the UE monitors residual capacity of a battery and detects that the quantity of electricity is lower than 5%.

In step 1507, the UE reports the residual capacity of the battery to the AS.

In step 1508, the AS notifies the UE that the quantity of electricity is insufficient and prompts a user to record IPTV service contents.

In step 1509, the user makes a confirmation via the UE.

In step 1510, the AS starts nPVR service.

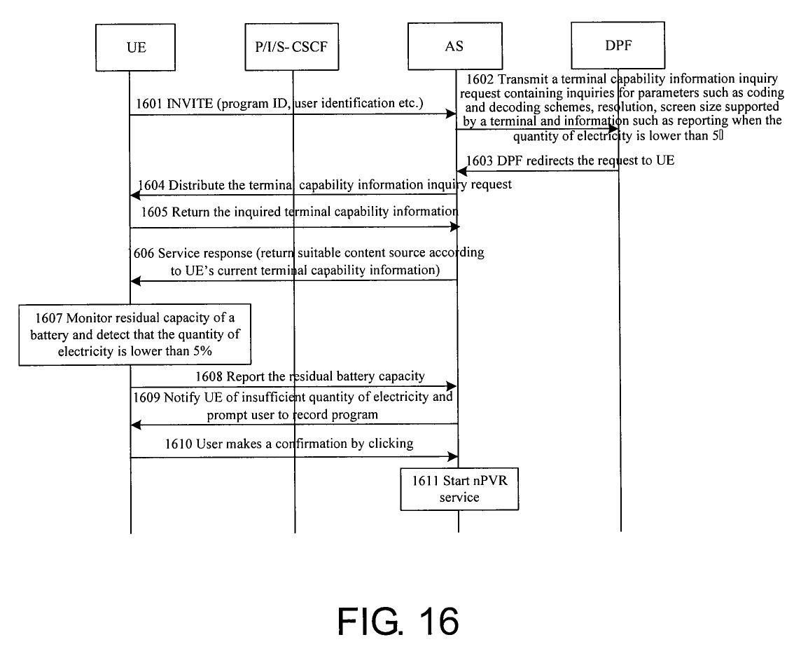

FIG. 16 is a flow chart of the ninth method for applying terminal capability information in an IMS-based IPTV service according to an exemplary embodiment of the present disclosure. A description is given with the following case as an example, in which case a user watches an LTV service via a UE, a DPF transmits the UE's terminal capability information inquired by an AS in redirecting mode, and the UE is required to report a case in which the battery capacity is lower than 5% to the AS, the AS alerts the user that the quantity of electricity is insufficient and prompts the user if recording is needed, and the AS performs nPVR service control after the user makes a confirmation via the UE. Specific steps are as follows.

In step 1601, a UE transmits an IP INVITE request carrying information such as channel ID and UE identification to an AS via a P/I/S-CSCF.

In step 1602, the AS transmits a terminal capability information inquiry request to a DPF, which contains inquiries for parameters such as coding and decoding schemes, resolution, screen size supported by a terminal and information such as reporting when the quantity of electricity is lower than 5%.

In step 1603, the DPF redirects the terminal capability information inquiry request transmitted by the AS to the UE.

In step 1604, the AS transmits the terminal capability information inquiry request to the UE.

In step 1605, the UE returns the inquired terminal capability values such as support for H.264 and MPEG4 in terms of coding and decoding, support for HDTV, support for 1080p in terms of screen and bandwidth of 5M, to the AS after receiving the request.

In step 1606, the AS returns a service response to the UE and selects suitable IPTV service content source for the UE according to information carried in the IP INVITE request and the returned terminal capability attribute. For example, if it is considered comprehensively that the UE supports high definition but the bandwidth is insufficient, IPTV service contents with standard definition can only be selected to distribute for the UE.

In step 1607, the UE monitors residual capacity of a battery and detects that the quantity of electricity is lower than 5%.

In step 1608, the UE reports the residual capacity of the battery to AS.

In step 1609, the AS notifies the UE that the quantity of electricity is insufficient and prompts a user to record IPTV service contents.

In step 1610, the user makes a confirmation via the UE.

In step 1611, the AS starts nPVR service.

These two above embodiments are both explained only with the case as an example, in which case the quantity of electricity is monitored. For the acquisition of a UE's terminal capability information, as an example, single UE's terminal capability is acquired. However, specific IPTV service implementations are not limited thereto.

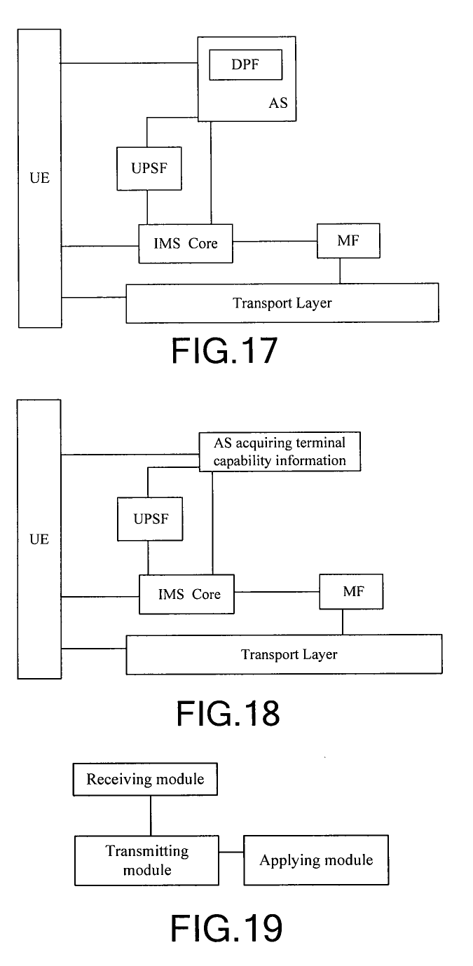

When the third aspect provided in an embodiment of the present disclosure is implemented, the system is shown in FIG. 17. A DPF is integrated in an AS, and the terminal capability information is transmitted between the DPF and the AS via an internal interface with the transmission mode being the same as that of the system in which a DPF and an AS are separated. The terminal capability information is transmitted directly between a DPF and a UE. Accordingly, the above nine embodiments may also be applied in the third aspect except that the internal interface is used instead when an AS and a DPF interact with each other.

The Second Aspect

In order to apply a UE's terminal capability information while providing an IPTV service for the UE, it is also possible for an AS and a UE to interact with each other to acquire the UE's terminal capability information.

FIG. 18 is a schematic architecture diagram of the second system for applying terminal capability information in an IPTV service according to an embodiment of the present disclosure. Similarly to FIG. 1, an AS acquires the terminal capability information from a UE.

The UE is configured to receive a terminal capability information inquiry request transmitted by the AS or to transmit the terminal capability information to the AS.

The AS is configured to transmit a terminal capability information inquiry request to the UE or to receive the terminal capability information transmitted by the UE and provide an IMS-based IPTV service for the UE according to the terminal capability information.

In this embodiment, the UE may actively transmit the terminal capability information to the AS. Alternatively, the terminal capability information is transmitted to the AS after the AS transmits the terminal capability information inquiry request.

In an embodiment of the present disclosure, an AS may also acquire a UE's terminal capability information or/and transmit the terminal capability information inquiry request via other network elements such as a P/I/S-CSCF, a UPSF or/and a GUP in an IMS Core. Alternatively, an AS may also acquire a UE's terminal capability information or/and transmit the terminal capability information inquiry request directly.

In an embodiment of the present disclosure, the terminal capability information inquiry request may also include inquiry content and a UE transmits the terminal capability information matching the inquiry content to an AS after receiving the inquiry request. The inquiry content includes terminal capability attribute inquiry information or terminal capability attribute inquiry information containing reporting condition. The reporting condition is immediate reporting, timed reporting or conditional reporting. The terminal capability attribute inquiry information is one of attribute inquiry information for at least one terminal capability and attribute inquiry information for a combination of a plurality of capability attributes.

The terminal capability information inquiry request may be an inquiry request for at least one piece of terminal capability information.

FIG. 19 is a schematic architecture diagram of the second apparatus for applying terminal capability information in an IMS-based IPTV service according to an embodiment of the present disclosure. As shown, the apparatus includes a receiving module, a transmitting module and an applying module.

The receiving module is configured to receive the terminal capability information and transmit the terminal capability information to a transmitting module.

The transmitting module is configured to receive the terminal capability information from the receiving module and transmit the terminal capability information to the applying module.

The applying module is configured to provide an IPTV service for the UE according to the terminal capability information received from the transmitting module.

The transmitting module is further configured to transmit the terminal capability information inquiry request.

Specifically, the receiving module is configured to receive the terminal capability information from the UE and the transmitting module is configured to transmit the terminal capability information inquiry request to the UE.

The apparatus is not only used as the apparatus used in the second aspect, but also used as the apparatus used in the third aspect.

Several specific embodiments will be illustrated.

In the first embodiment, a UE performs a third party registration with an AS and during registration, the terminal capability information is reported to the AS via an S-CSCF. This process is similar to that shown in FIG. 9, except that a DPF is replaced with an AS.

In the second embodiment, a UE performs a third party registration with an AS and reports the terminal capability information to the AS directly after successful registration. This process is similar to that shown in FIG. 10.

In the third embodiment, a UE performs a third party registration with an AS and reports the terminal capability information to the AS via an S-CSCF after successful registration. This process is similar to that shown in FIG. 11, except that a DPF is replaced with an AS.

In the fourth embodiment, a UE performs a third party registration with an AS and the AS subscribes the terminal capability information from the UE via an S-CSCF after successful registration. This process is similar to that shown in FIG. 12, except that a DPF is replaced with an AS.

In the fifth embodiment, a UE performs a third party registration with an AS and the AS inquires of the UE about the terminal capability information directly. This process is similar to that shown in FIG. 13, except that a DPF is replaced with an AS.

In the above five embodiments, the terminal capability information is transmitted during or after a UE performs an IMS registration process. Specific implementations are not limited thereto. A UE may transmit the terminal capability information at any other time, which doesn't necessarily associate with an IMS registration process.

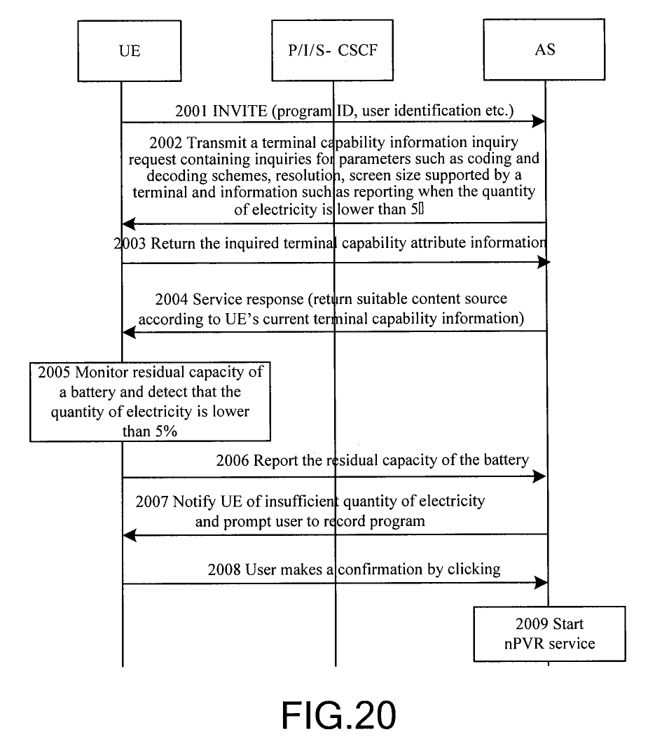

FIG. 20 is a flow chart of the sixth method for applying terminal capability information in an IPTV service according to the second aspect of an exemplary embodiment of the present disclosure. A description is given with the following case as an example, in which case a user watches an LTV service via a UE, a DPF transmits the UE's terminal capability information inquired by an AS in routing mode, and the UE is required to report a case in which the battery capacity is lower than 5% to the AS, the AS alerts a user that the quantity of electricity is insufficient and prompts the user if recording is needed, and the AS performs nPVR service control after the user makes a confirmation via the UE. Specific steps are as follows.

In step 2001, a UE transmits an IP INVITE request carrying information such as channel ID and UE identification to an AS via a P/I/S-CSCF.

In step 2002, the AS transmits a terminal capability information inquiry request to the UE, which contains inquiries for parameters such as coding and decoding schemes, resolution, screen size supported by a terminal and information such as reporting when the quantity of electricity is lower than 5%.

In step 2003, the UE returns the inquired terminal capability values such as support for H.264 and MPEG4 in terms of coding and decoding schemes, support for HDTV, support for 1080p in terms of screen and bandwidth of 5M, to the AS after receiving the request.

In step 2004, the AS returns a service response to the UE and selects suitable IPTV service content source for the UE according to information carried in the IP INVITE request and the returned terminal capability information. For example, if it is considered that the UE supports high definition but the bandwidth is insufficient, then IPTV service contents with standard definition can only be selected to distribute for the UE.

In step 2005, the UE monitors residual capacity of a battery and detects that the quantity of electricity is lower than 5%.

In step 2006, the UE reports the residual capacity of the battery to the AS. In step 2007, the AS notifies the UE that the quantity of electricity is insufficient and prompts a user to record IPTV service contents.

In step 2008, the user makes a confirmation via the UE.

In step 2009, the AS starts nPVR service.

As can be seen from the above-motioned three aspects, in embodiments of the present disclosure, corresponding services can be adjusted timely with the change of terminal capability information before or during providing an IPTV service by acquiring, managing and applying the terminal capability information in real time in the system carrying IPTV service, which provides the user with perfect service experience.

The above is the description of specific embodiments of the present disclosure. In specific implementations, the method of the present disclosure may be modified appropriately to meet specific requirements of specific circumstances. Therefore it is appreciated that specific implementations according to the present disclosure are only exemplary and not intended to limit the protection scope of the present disclosure.

What is claimed is:

1. A system for applying terminal capability information in an Internet Protocol Television (IPTV) service, comprising a user equipment (UE), a core IP multimedia subsystem (Core IMS), a device profile function (DPF) and an application server, wherein:
the UE is configured to transmit the terminal capability information and receive the IPTV service;
the Core IMS is configured to forward the terminal capability information received from the UE to the DPF;
the DPF is configured to transmit the terminal capability information to the application server; and
the application server is configured to provide the IPTV service for the UE according to the terminal capability information.

2. The system of claim 1, wherein the DPF is further configured to forward a terminal capability information inquiry request transmitted by the application server to the UE or transmit a terminal capability information inquiry request to the UE.

3. The system of claim 2, wherein the Core IMS is further configured to forward the terminal capability information inquiry request from the DPF to the UE.

4. The system of claim 2, wherein the Core IMS is further configured to forward the terminal capability information from the DPF to the application server or forward the terminal capability information inquiry request from the application server to the DPF.

5. The system of claim 2, wherein the DPF is a standalone entity or integrated in the application server.

6. An apparatus for applying terminal capability information in an Internet Protocol Television (IPTV) service, comprising a receiving module, a transmitting module and an applying module, wherein:
the receiving module is configured to receive the terminal capability information and transmit the terminal capability information to the transmitting module;
the transmitting module is configured to receive the terminal capability information from the receiving module and transmit the terminal capability information to the applying module; and
the applying module is configured to provide the IPTV service for a user equipment (UE) according to the terminal capability information received from the transmitting module.

7. The apparatus of claim 6, wherein:
the receiving module is further configured to receive a terminal capability information inquiry request and transmit the terminal capability information inquiry request to the transmitting module; and
the transmitting module is further configured to transmit the terminal capability information inquiry request received from the receiving module.

8. The apparatus of claim 6, wherein:
the receiving module is further configured to receive the terminal capability information from the UE; and
the transmitting module is further configured to transmit a terminal capability information inquiry request to the UE.

9. A method for applying terminal capability information in an Internet Protocol Television (IPTV) service, wherein the method comprises:
receiving the terminal capability information transmitted by a user equipment (UE) via a Core IP multimedia subsystem (Core IMS); and
providing the IPTV service for the UE according to the acquired terminal capability information.

10. The method of claim 9, wherein the providing the IPTV service for the UE according to the acquired terminal capability information is implemented by an application server.

11. The method of claim 9, wherein the receiving the terminal capability information transmitted by the UE via the Core IMS is implemented by one of a device profile function and an application server.

12. The method of claim 11, wherein if the receiving the terminal capability information transmitted by the UE via the Core IMS is implemented by the device profile function, the method further comprises:
transmitting, by the device profile function, the terminal capability information to the application server.

13. The method of claim 11, wherein:
if the receiving the terminal capability information transmitted by the UE via the Core IMS is implemented by the device profile function, the method further comprises:
transmitting, by the device profile function, a terminal capability information inquiry request to the UE via the Core IMS; and
if the receiving the terminal capability information transmitted from the UE via the Core IMS is implemented by the application server, the method further comprises:
transmitting, by the application server, the terminal capability information inquiry request to the device profile function or to the UE via the Core IMS.

14. The method of claim 13, wherein the terminal capability information inquiry request transmitted by the device profile function or the application server further comprises inquiry content.

15. The method of claim 14, wherein the inquiry content carried in the terminal capability information inquiry request comprises one of terminal capability attribute inquiry information and terminal capability attribute inquiry information containing reporting condition.

16. The method of claim 15, wherein:
the reporting condition is one of immediate reporting, timed reporting and conditional reporting; and
the terminal capability attribute inquiry information is one of attribute inquiry information for at least one terminal capability and attribute inquiry information for a combination of a plurality of capability attributes.

17. The method of claim 13, wherein the terminal capability information inquiry request is an inquiry request for at least one piece of terminal capability information.

18. The method of claim 11, wherein the device profile function is provided in the application server or provided separately.
